(19) United States
(12) Patent Application Publication
(10) Pub. No.: US 2017/0318728 A1
(43) Pub. Date: Nov. 9, 2017

(54) AGRICULTURAL IMPLEMENT WITH EASILY SERVICED TRUNNION

(71) Applicant: CNH Industrial America LLC, New Holland, PA (US)

(72) Inventors: Matthew R. Sudbrink, Metamora, IL (US); Dean A. Knobloch, Tucson, AZ (US)

(73) Assignee: CNH Industrial America LLC, New Holland, PA (US)

(21) Appl. No.: 15/148,487

(22) Filed: May 6, 2016

(51) Int. Cl. A01B 59/00; F16C 11/02; A01B 63/32; A01B 5/04; A01B 59/042

(52) U.S. Cl. CPC A01B 59/002; F16C 11/02; A01B 59/042; A01B 5/04; A01B 63/32

(57) ABSTRACT

An agricultural implement includes a frame and an adjustment system on the frame. The adjustment system includes a first component and a second component connected by a trunnion connection. The trunnion connection includes first and second opposed confronting trunnion blocks, each defining a hole therethrough, the holes being aligned one with the other. A trunnion shaft is disposed in the holes of the trunnion blocks and has ends extending beyond outer surfaces of the trunnion blocks. At least one end of the trunnion shaft defines an opening therethrough. End stops are provided at each end of the trunnion shaft, at least one of the end stops having a portion insertable into the opening. The end stops are larger than the aligned holes to prevent withdrawal of the trunnion shaft from the trunnion blocks.

### BACKGROUND OF THE INVENTION

### 1. Field of the Invention

The present invention generally relates to agricultural implements, and, more particularly, to connections between components of adjustment systems in tillage implements.

### 2. Description of the Related Art

Trunnions can be used to make strong connections at locations where one of the connected components is moved at an angle with respect to another component to which it is connected. As is known to those skilled in the art, in simple form, a trunnion connection usually consists of a trunnion shaft that is connected to, or even integral with a first component, and trunnion blocks supporting opposite ends of the trunnion shaft. The trunnion blocks may be connected to, or integral with a second component or components in the trunnion connection. The trunnion shaft is able to rotate in the trunnion blocks, thereby allowing the component connected thereto to move through changing angles relative to the trunnion blocks and the component or components that support the trunnion blocks. In more sophisticated designs of trunnion connections, the trunnion shaft may include an opening therethrough, to which the first component is adjustably connected. This enables the first component to be moved relative to the trunnion shaft and the trunnion shaft to move relative to the second component or components supporting the trunnion blocks. This allows a connection between components, for example, that not only change angularly relative to one another, but also experience extension or retraction between them.

In the case of a tillage implement, a trunnion connection can be used between linkage components of an adjustment system between a linear actuator, such as a hydraulic cylinder, and rotating shafts that raise and lower the ground working tools, to control the depth of tillage when working in a field or for raising the unit sufficiently for transporting from one location to another location.

Use of trunnion connections on agricultural equipment such as field cultivator equipment has been known for a long time, but the use thereof is not without drawbacks. Known trunnion designs have captured the trunnion shaft between trunnion blocks that are fixed permanently in place, such as by welding. For example, in the linkage system described previously, a trunnion shaft has been captured between trunnion blocks that are welded to opposite sides of a tube, shaft or component in the linkage system. The trunnion shaft is provided with a hole therethrough, and a shaft or other structure in the linkage system can be extended through the hole and thereby connected to and disconnected from the trunnion shaft. This enables disconnection and reconnection of the overall assembly, but does not allow for servicing or replacing the trunnion shaft without replacing the trunnion blocks and support shaft to which they are welded. Further, in such designs, initial manufacture and assembly are difficult in that the rotating trunnion shaft must be captured between the trunnion blocks before the trunnion blocks are welded in place and before final finishing, such as painting.

To improve serviceability, it has been known to attach the trunnion blocks by a plurality of bolts. However, if a bolt becomes loosened the trunnion connection can become unstable, causing damages to components along the linkage system. Further, while servicing is facilitated in making disassembly possible, servicing requires tools for disconnecting and reconnecting the trunnion blocks to the component.

What is needed in the art is a more easily serviced trunnion assembly that maintains the integrity of the trunnion connection during use but can be disassembled for servicing easily and quickly.

### SUMMARY OF THE INVENTION

The present invention provides an agricultural implement with a trunnion connection having permanently connected trunnion blocks and a trunnion shaft that can be connected to and disconnected from the trunnion blocks.

The invention in one form is directed to an agricultural implement with a frame; an adjustment system carried by the frame, the adjustment system including a first component and a second component; and a trunnion connection between the first component and the second component. The trunnion connection includes first and second trunnion blocks disposed in a confronting, spaced relationship to each other, the trunnion blocks defining aligned holes therethrough and being connected to the second component. A trunnion shaft is connected to the first component and is disposed in the aligned holes of the trunnion blocks. The trunnion shaft extends between the trunnion blocks and through the aligned holes, with ends of the trunnion shaft projecting outwardly of each trunnion block. At least one of the ends of the trunnion shaft defines an opening therethrough outwardly of the trunnion block adjacent thereto. End stops at the ends of the trunnion shaft include at least one that is disposed in the opening.

The invention in another form is directed to a trunnion connection with first and second trunnion blocks disposed in a confronting, spaced relationship to each other, the trunnion blocks defining aligned holes therethrough. A trunnion shaft is disposed in the aligned holes and extends between the trunnion blocks and through the aligned holes, with ends of the trunnion shaft projecting outwardly of each trunnion block. At least one of the ends of the trunnion shaft defines an opening therethrough outwardly of the trunnion block adjacent thereto. End stops at the ends of the trunnion shaft are larger than the aligned holes, and at least one of the end stops is has a portion disposed in the opening.

An advantage of the present invention is that a trunnion connection can be disassembled easily for service, adjustment or repair.

Another advantage of the invention is that an easily serviced trunnion is provided with rigidity and strength.

Yet another advantage of the invention is that manufacture is facilitated by simplifying assembly and fabrication.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a top schematic illustration of an embodiment of an agricultural implement having an easily serviced trunnion as disclosed herein;

FIG. 2 is a rear view of the field cultivator shown in FIG. 1;

FIG. 3 is an enlarged perspective view of a portion of the agricultural implement shown in FIGS. 1 and 2, better showing an embodiment of a trunnion connection formed according to the present invention;

FIG. 4 is an exploded view of an adjustment system in the agricultural implement shown in FIG. 1, which includes the trunnion connection shown in FIG. 3;

FIG. 5 is a perspective view of a trunnion shaft in the trunnion connection;

FIG. 6 is an elevational view of the trunnion shaft;

FIG. 7 is another elevational view of the trunnion shaft, illustrating the shaft rotated 90° from the view shown in FIG. 6;

FIG. 8 a perspective view of another embodiment for a component of the trunnion connection; and

FIG. 9 is an elevational view of another embodiment for the trunnion shaft.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

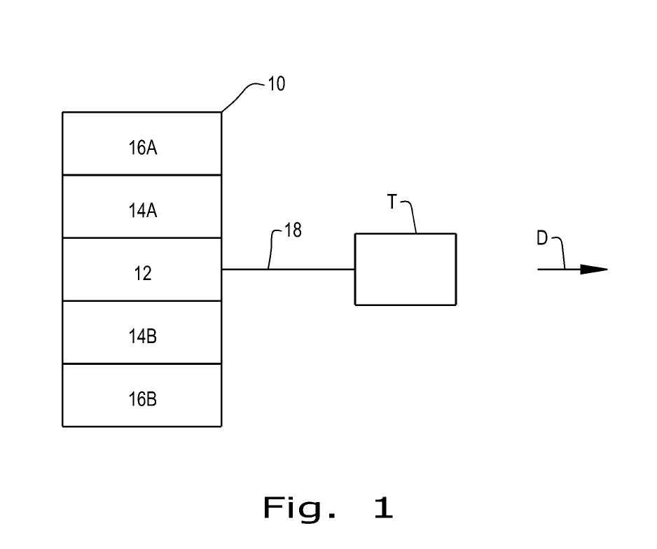

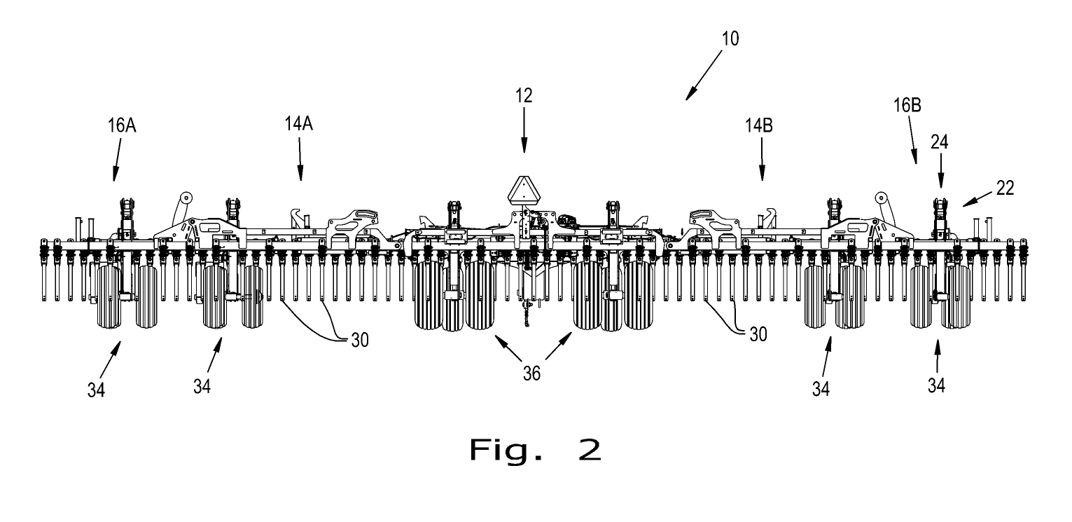

Referring now to the drawings, and more particularly to FIG. 1 and FIG. 2, there is shown an embodiment of an agricultural implement 10, shown as a field cultivator, incorporating the present invention. Field cultivator 10 is configured as a multi-section field cultivator, and includes a center frame section 12 and inner and outer wing sections 14 and 16. In the illustrated embodiment, field cultivator 10 has a duai-fold configuration with two wing sections designated 14A and 16A on one side of center frame section 12, and two other wing sections designated 14B and 16B on an opposite side of center frame section 12. Wing sections 14A and 14B are each inner wing sections, and wing sections 16A and 16B are each outer wing sections. Center frame section 12 is the center section that is towed directly by a traction unit, such as an agricultural tractor T. A pull hitch 18 extends forward from center frame section 12 and is coupled with the traction unit in known manner so that the traction unit can tow implement 10 in a travel direction D.

Cultivator 10 includes an adjustment system 22 having an easily serviced trunnion connection 24 therein, as will be described in greater detail hereinafter. In the exemplary illustration of the drawings, adjustment system 22 and a trunnion connection 24 are shown with respect to a frame 26 of wing section 16B, but it should be understood that the other sections 12, 14 and 16 can advantageously use trunnion connection 24 in similar adjustment systems to adjustment system 22 or for other operating systems and connections therein.

Center frame section 12 and wing sections 14A, 14B, 16A, 16B carry field working devices such as cultivator shanks 30, which may include shovels at the lower ends thereof for tilling the soil as implement 10 is pulled in direction D. Wing lift wheels 34 are provided for wing sections 14A, 14B, 16A, 16B. Main lift and transport wheels 36 are provided for center frame section 12.

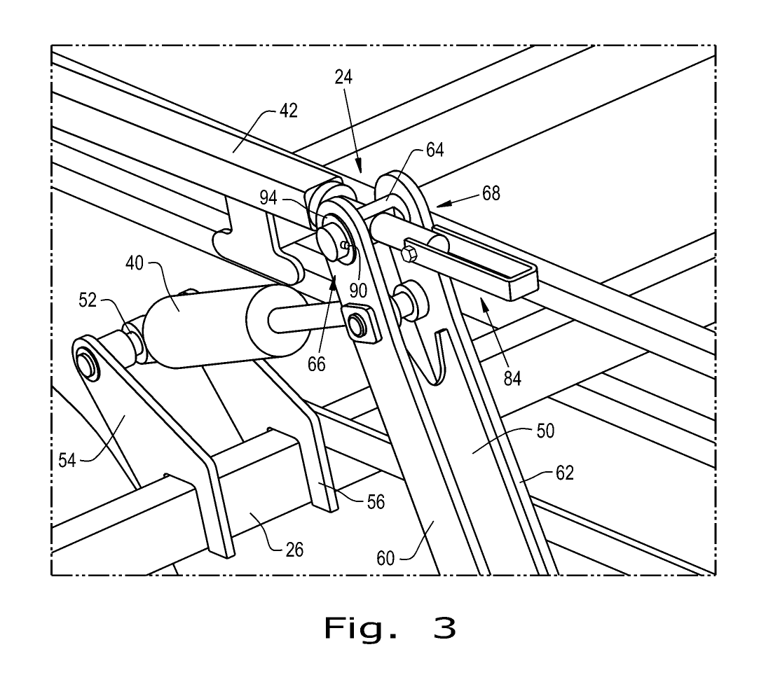

Referring now additionally to FIGS. 3 & 4, adjustment system 22 is shown for the adjustment of wing lift wheels 34 in wing section 16B, which are used for raising and lowering wing section 16B during field operation of cultivator 10 to control the penetration depth of shanks 30. As mentioned previously, others of the cultivator sections 12, 14, 16 may incorporate similar adjustment systems for the lift wheels 34, 36 thereof.

A hydraulic lift cylinder or actuator 40 is connected to lift wheels 34 through adjustment system 22 that includes a first component or linkage system shaft 42 which is connected at one end to an operating crank 44 on a pivot tube 46. Also connected to crank 44 is a pedestal arm 48 carrying wing lift wheels 34. Accordingly, extension and retraction of shaft 42 rotates pivot tube 46 and crank 44 thereon, and thereby raising or lowering wing lift wheel 34 relative to frame 26 carrying field cultivator shanks 30.

The end of shaft 42 opposite to the connection to crank 44 is connected through trunnion connection 24 to a second component or pivotal support 50. Hydraulic cylinder 40 is mounted to a shaft 52 connected between a pair of anchors 54, 56. Extension and retraction of the hydraulic cylinder 40 results in pivoting support 50, linear movement of linkage system shaft 42, rotation of pivot tube 46 and that resulted raising or lowering of wing lift wheels 34. The interconnection of trunnion connection 24 between the hydraulic cylinder 40, linkage system shaft 42 and support 50 allows the transfer of force between the rotating and linear moving components as the relative angles between the components change.

Trunnion connection 24 can be seen most completely in the exploded view of FIG. 4. Trunnion connection 24 includes trunnion blocks 60, 62, a trunnion shaft 64 and outside end stops 66, 68. Trunnion blocks 60, 62 are provided in opposed spaced relationship by their attachment on opposite sides of support 50. Trunnion blocks 60, 62 can be attached to support 50 by welding or other suitable means. Each trunnion blocks 60, 62 defines, respectively, a hole 70, 72 there through, the holes 70, 72 being aligned one with the other in a space beyond support 50. That is, trunnion blocks 60, 62 extend beyond a distal end of support 50, and holes 70, 72 are provided in those portions of trunnion blocks 60, 62 that extend beyond support 50. Accordingly, the area between trunnion blocks 60, 62 in the region of holes 70, 72 is void.

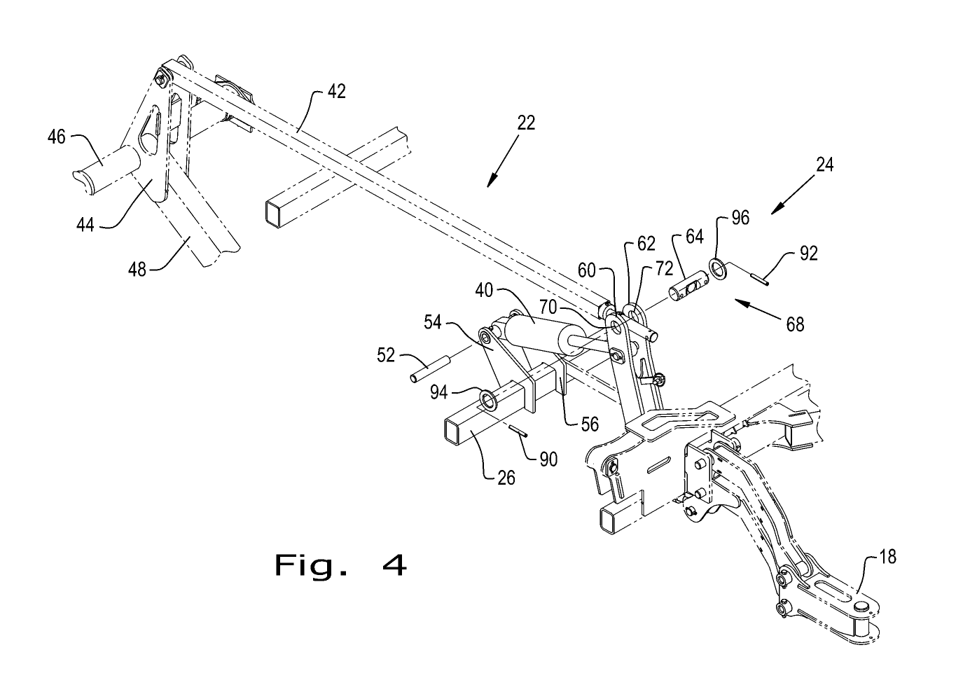

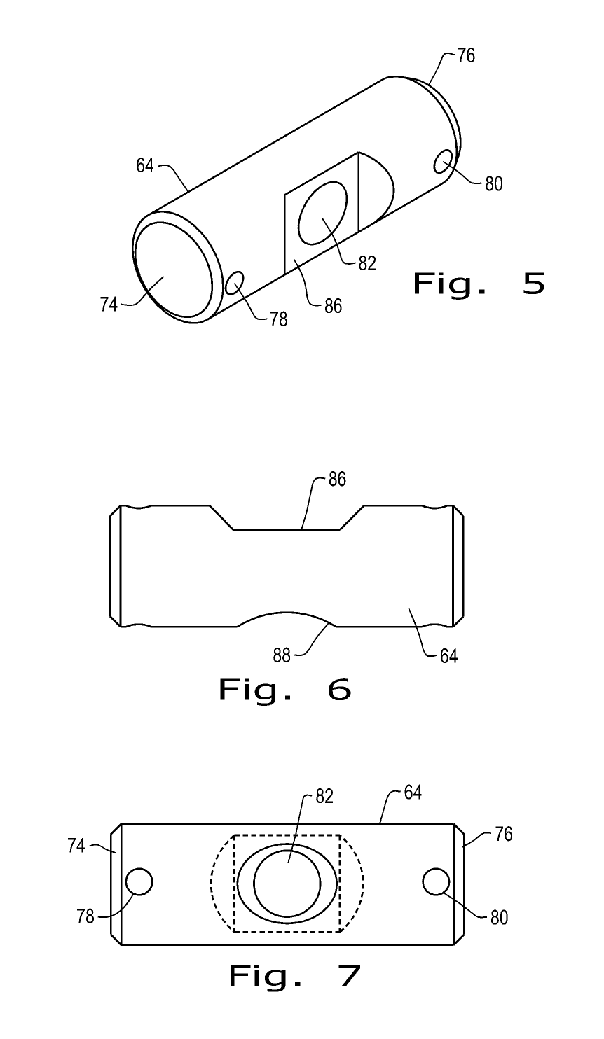

Referring now to FIGS. 5-7, trunnion shaft 64 is a rod of appropriate diameter to slide through holes 70, 72, but without being overly loose therein. Trunnion shaft 64 can include tapered ends 74, 76 to facilitate insertion through holes 70, 72. Near each end thereof, trunnion shaft 64 defines an opening 78, 80 which cooperate with end stops 66, 68 as will be described hereinafter. Further, trunnion shaft 64 defines a central aperture 82 of sufficient diameter to receive therein linkage system shaft 42, which can be held thereon by a threaded end system 84 (FIG. 3). A shaped land in the nature of a flat region 86 is defined surrounding one entrance to aperture 82 and a shaped land in the nature of a concave region 88 is provided at the other entrance to aperture 82 for receiving and retaining in seated engagement the end of shaft 42 and the base of end system 84. In its installed arrangement, trunnion shaft 64 is received in trunnion blocks 60, 62, being disposed within holes 70, 72, with end portions of trunnion shaft 64 extending beyond the outer surfaces of trunnion blocks 60, 62 so that openings 78, 80 in trunnion shaft 64 are exposed near the outside surfaces of trunnion blocks 60, 62.

Referring now again primarily to FIGS. 3 and 4, end stops 66, 68 are received in openings 78, 80 and provide an obstacle larger than the opening diameters of holes 70, 72 so that, when trunnion shaft 64 is installed with the end stops in place, trunnion shaft 64 cannot be withdrawn from either trunnion block 60 or trunnion block 62. In the exemplary embodiment, end stops 66, 68 include roll pins 90, 92 and washers 94, 96, respectively. Roll pins 90, 92 are received in openings 78, 80 to retain washers 94, 96 on trunnion shaft 64, and washers 94, 96 are of sufficient diameter to project beyond each opening 78, 80.

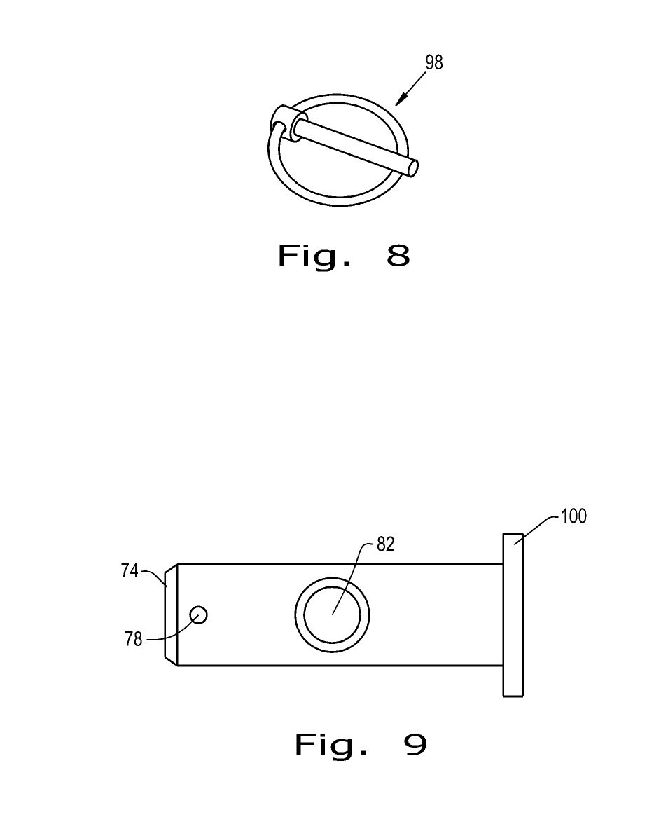

It should be understood that structures other than roll pins can be used in end stops 66, 68 to provide portions of the end stops that are received in and removable from openings 78, 80. For example, one or both roll pins 90, 92 can be replaced by a linchpin such as a Klik pin 98 (FIG. 8) received in the openings 78, 80. It should be understood, also, that trunnion shaft 64 can be configured with a fixed head 100 (FIG. 9) at one end thereof, and a removable roll pin 90 or 92, or a linchpin 98 at the other end thereof. While shown with washers 94, 96 it should be understood that some end stops may not require the use of a washer.

The trunnion connection described herein provides several advantages. The assembly of trunnion blocks 60, 62 with support 50 can be rigid and strong, such as by welding, and can be completed with final finishing, such as painting, before trunnion shaft 64 is attached thereto. Trunnion shaft 64 is attached by inserting the trunnion shaft through aligned holes 70, 72. The trunnion shaft is positioned with openings 78, 80 outwardly of trunnion blocks 60, 62. Washers 94, 96 are placed on trunnion shaft 64 and roll pins 90, 92, linchpins 98 or other suitable structures are inserted. Thereafter, shaft 42 can be inserted through aperture 82 and connected thereto.

If servicing is required, shaft 42 is disconnected from trunnion shaft 64. At least one end stop 66, 68 is removed, and trunnion shaft 64 is withdrawn from trunnion blocks 60, 62. A replacement trunnion shaft 64 can be reinstalled as described above. Alternatively, trunnion shaft 64 can be repaired and reinstalled. Removal is easy and quick, particularly when a tool-less end stop is used, such as one using a linchpin 98.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural implement, comprising:
a frame;
an adjustment system carried by said frame, said adjustment system including a first component and a second component; and
a trunnion connection between said first component and said second component, said trunnion connection including:
first and second trunnion blocks disposed in a confronting, spaced relationship to each other, said trunnion blocks defining aligned holes therethrough and being connected to said second component;
a trunnion shaft connected to said first component and being disposed in said aligned holes and extending between said trunnion blocks and through said aligned holes, with ends of said trunnion shaft projecting outwardly of each said trunnion block;
at least one of said ends of said trunnion shaft defining an opening therethrough outwardly of the trunnion block adjacent thereto; and
end stops at the ends of said trunnion shaft, at least one of said end stops have a portion thereof removably disposed in said opening.

2. The agricultural implement according to claim 1, wherein each end of said trunnion shaft defines an opening therethrough; and each of said end stops has a portion received in said openings.

3. The agricultural implement according to claim 2, wherein at least one of said end stops includes a roll pin.

4. The agricultural implement according to claim 2, wherein at least one of said end stops includes a linchpin.

5. The agricultural implement according to claim 1, wherein at least one of said end stops includes a roll pin.

6. The agricultural implement according to claim 1, wherein at least one of said end stops includes a linchpin.

7. The agricultural implement according to claim 1, wherein one of said end stops is a head on said trunnion shaft.

8. The agricultural implement according to claim 1, said trunnion shaft defining an aperture extending through said trunnion shaft at a position between said trunnion blocks, and said first component being connected to said trunnion shaft by way of said aperture.

9. The agricultural implement according to claim 8, said trunnion shaft including a shaped land surrounding one end of said aperture.

10. The agricultural implement according to claim 8, said trunnion shaft including shaped lands surrounding each end of said aperture.

11. The agricultural implement according to claim 10, one of said shaped lands being concave.

12. The agricultural implement according to claim 10, one of said shaped lands being flat.

13. A trunnion connection between first and second components, said trunnion connection comprising:
first and second trunnion blocks connected to the second component and disposed in a confronting, spaced relationship to each other, said trunnion blocks defining aligned holes therethrough;
a trunnion shaft connected to the first component and disposed in said aligned holes and extending between said trunnion blocks and through said aligned holes, with ends of said trunnion shaft projecting outwardly of each said trunnion block;
at least one of said ends of said trunnion shaft defining an opening therethrough outwardly of the trunnion block adjacent thereto; and
end stops at the ends of said trunnion shaft, said end stops being larger than said aligned holes, and at least one of said end stops including a portion removably disposed in said opening.

14. The trunnion connection according to claim 13, wherein each end of said trunnion shaft defines an opening therethrough; and each of said end stops includes a portion disposed in said openings.

15. The trunnion connection according to claim 14, wherein at least one of said end stops includes a roll pin.

16. The trunnion connection according to claim 14, wherein at least one of said end stops includes a linchpin.

17. The trunnion connection according to claim 13, wherein said at least one of said end stops includes a roll pin in said opening and a washer disposed on said trunnion shaft between said roll pin and said trunnion block adjacent said opening.

18. The trunnion connection according to claim 13, wherein said at least one of said end stops includes a linchpin in said opening and a washer disposed on said trunnion shaft between said linchpin and said trunnion block adjacent said opening.

19. The trunnion connection according to claim 13, wherein one of said end stops is a head on said trunnion shaft.

20. The trunnion connection according to claim 13, wherein said trunnion shaft defines an aperture extending therethrough and positioned between said trunnion blocks.
